(19) United States
(12) Patent Application Publication
(10) Pub. No.: US 2015/0221272 A1
(43) Pub. Date: Aug. 6, 2015

(54) Array Substrate Driving Circuit, Array Substrate, And Corresponding Liquid Crystal Display

(71) Applicant: Shenzhen China Star Optoelectronics Technology Co., Ltd., Shenzhen, Guangdong (CN)

(72) Inventor: Xiangyang Xu, Shenzhen City (CN)

(21) Appl. No.: 14/235,129

(22) PCT Filed: Jan. 8, 2014
(86) PCT No.: PCT/CN2014/070316

§ 371 Date: Jan. 27, 2014

(51) Int. Cl. G09G 3/36

(52) U.S. Cl. CPC G09G 3/3659; G09G 3/36; G09G 3/3648; G09G 3/3674; G09G 2310/0272; G09G 2320/0223

(57) ABSTRACT

The present invention provides an array substrate driving circuit, which includes a plurality of GoA driving units used to drive a plurality of gate lines, wherein each GoA driving unit is interconnected to one gate line. Wherein the GoA driving units connected with odd row of gate lines are disposed on one side of the array substrate, and wherein the GoA driving units connected with even row of gate lines are disposed on the other side of the array substrate. And wherein each of the GoA driving units are provided with two driving signal input ends and an output end, those two driving signal input ends are interconnected to output ends of upstream and downstream driving units, respectively to receive driving signals from the upstream and downstream driving units. A driving signal is exported from the output end thereof to an interconnected gate line. The GoA driving units located on both sides of the array substrate will drive each of the gate lines of the array substrate alternatively. The present invention further provides an array substrate and liquid crystal display. With the provision of the present invention, the estate area occupied by the driving circuit is tremendously reduced. This is really beneficial to the realization of narrow-boarder of the liquid crystal display device.

### CROSS REFERENCE

This application is claiming a priority arisen from a patent application, entitled with “Array Substrate Driving Circuit, Array Substrate, And Corresponding Liquid Crystal Display”, submitted to China Patent Office on Dec. 26, 2013, designated with an Application Number 201310730254.4. The whole and complete disclosure of such patent application is hereby incorporated by reference. This application also related to National Stage Application No.: ______ (Attorney Docket No. CP14009), submitted on the same date, entitled, “Array Substrate Driving Circuit, Array Substrate, And Corresponding Liquid Crystal Display” assigned to the same assignee.

### FIELD OF THE INVENTION

The present invention relates to the technical field of thin film transistor liquid crystal display, and more particularly, to an array substrate driving circuit, array substrate, and corresponding liquid crystal display.

### DESCRIPTION OF PRIOR ART

Technology in Liquid crystal display has a great leap such that both the dimension as well as the quality of resolution has great advancement. The liquid crystal display features compact, slim, low energy consumption, and low radiation. As a result, the liquid crystal display has become the main stream of the flat display device. With the ongoing development of the liquid crystal display, high resolution, high contract, high refresh rate, narrow-boarder frame, and compact slim design have become the trend of the development of the liquid crystal display.

Currently, thin film transistors have been used to configure the gate on array, GoA, driving circuit. In order to realize the purpose of liquid crystal with narrow-boarder, compact and low cost, simplification as well as reducing the dimension of the GoA circuit has become very important.

As shown in FIG. 1, a configurational and illustrational view of a prior art array substrate driving circuit is shown, and in which the driving circuit is arranged on one side of the array substrate. In this array substrate with driving circuit arranged on one side, each row is arranged with one GoA driving unit which in general is configured with seven (7) thin film transistors. Accordingly, for the array substrate, the side with driving circuit is wider than the other side without the circuit. Accordingly, this asymmetric design is not good for the realization of narrow-boarder.

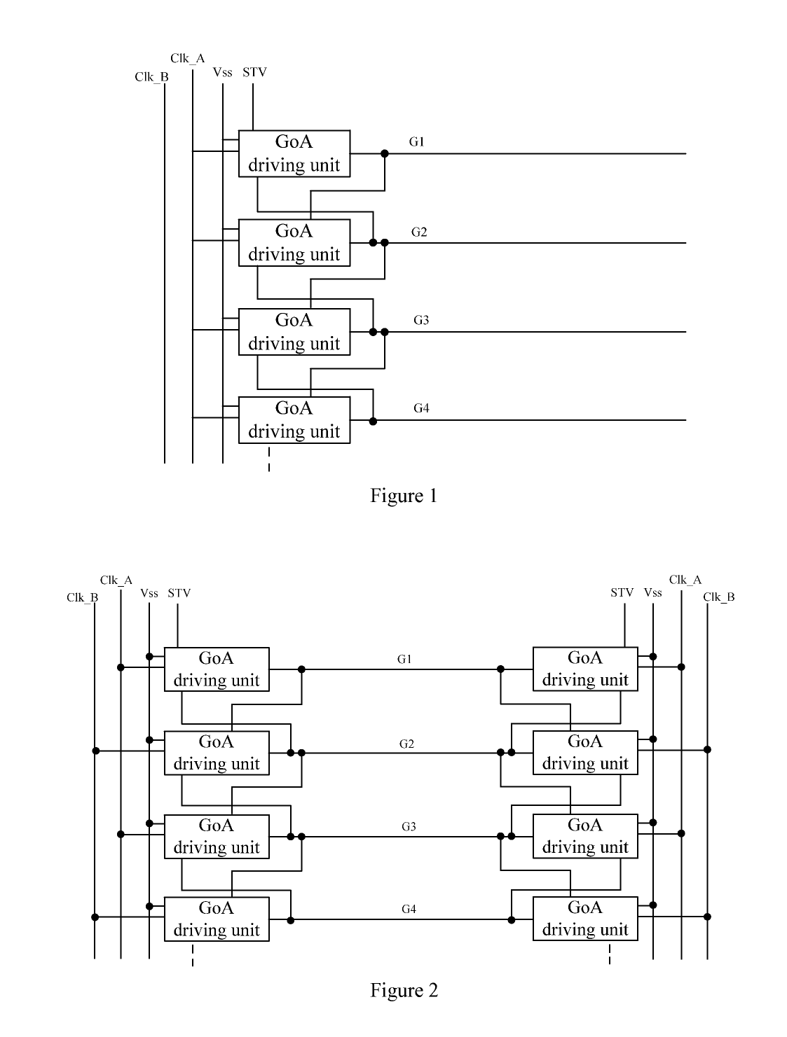

As shown in FIG. 2, a configurational and illustrational view of a prior art array substrate driving circuit is shown, and in which every row has two corresponding GoA driving units to perform the driving. This is also referred to dual-side driving. Even this dual-side driving can really upgrade the driving capability, however, it is too complicated to implement in a cost-effective way. In addition, the driving units take a great deal of area on the array substrate, and is even detrimental to the realization of narrow-boarder.

### SUMMARY OF THE INVENTION

It is an object of the present invention to provide an array substrate driving circuit, array substrate, and corresponding liquid crystal display so as to resolve the technical issues encountered by the prior art.

In order to resolve the technical issues encountered by the prior art, the present invention provides an array substrate driving circuit, including a plurality of GoA driving units used to drive a plurality of gate lines, wherein each GoA driving unit is interconnected to one gate line;

wherein the GoA driving units connected with odd row of gate lines are disposed on one side of the array substrate, and wherein the GoA driving units connected with even row of gate lines are disposed on the other side of the array substrate; and

wherein each of the GoA driving units being associated with a first driving signal input end, a second driving signal input end and a signal output end, wherein the first driving signal input end is interconnected with the signal output end of an upstream GoA driving unit, and the second driving signal input end is interconnected with the signal output end of a downstream GoA driving unit, wherein the gate lines interconnected with the gate lines of the GoA driving units are interconnected to the signal output ends.

Wherein each of the GoA driving units includes a first thin film transistor, a second thin film transistor, a third thin film transistor, a fourth thin film transistor, and a storage capacitance, wherein

source and gate electrodes of the first thin film transistor are interconnected to the signal output end of the upstream GoA driving unit, and drain electrode of the first thin film transistor is interconnected to a gate electrode of the second thin film transistor, a first end of a storage capacitance, and further connected to a drain electrode of the third thin firm transistor, respectively;

a source electrode of the second thin film transistor is interconnected with an output end of a clock, a gate electrode of the second thin film transistor is interconnected to the first end of the storage capacitance, a drain electrode and an signal output end of the second thin film transistor are interconnected together, and further interconnected to a source gate of the fourth thin film transistor, and a second end of the storage capacitance;

a source electrode of the third thin film transistor is interconnected to the first end of the storage capacitance, and a gate electrode of the third thin film transistor is interconnected to a signal output end of a downstream GoA driving unit, and a source electrode is interconnected to a low potential line or ground; and

a source electrode and a signal output end of the fourth thin film transistor are interconnected to the second end of the storage capacitance, a gate electrode of the fourth thin film transistor is interconnected to the signal output end of a downstream GoA driving unit, and a drain electrode of the fourth thin film transistor is interconnected to a low potential line or ground.

Wherein a clock signal output end connected to each of the GoA driving units connected by odd row of the gate lines is referred to a first clock signal output end, and wherein a clock signal output end connected to each of the GoA driving units connected by even row of the gate lines is referred to a first clock signal output end; and wherein the first and second clock signals have the same cyclic period, but with half cycle difference in polarity.

Wherein first driving signal input ends of the GoA driving units located at the upfront is each interconnected with a scanning triggering signal line so as to trigger operation of the GoA driving unit located at the upfront.

Correspondingly, the present invention further provides an array substrate for liquid crystal display, includes a plurality of pixels defined by gate lines and data lines, and each of the pixels is configured with thin film transistor and pixel electrode; further including a plurality of GoA driving units used to drive the plurality of gate lines, wherein each GoA driving unit is interconnected to one gate line at an output end thereof;

wherein the GoA driving units connected with odd row of gate lines are disposed on one side of the array substrate, and wherein the GoA driving units connected with even row of gate lines are disposed on the other side of the array substrate; and

wherein each of the GoA driving units being associated with a first driving signal input end, a second driving signal input end and a signal output end, wherein the first driving signal input end is interconnected with the signal output end of an upstream GoA driving unit, and the second driving signal input end is interconnected with the signal output end of a downstream GoA driving unit, wherein the gate lines interconnected with the gate lines of the GoA driving units are interconnected to the signal output ends.

Wherein each of the GoA driving units includes a first thin film transistor, a second thin film transistor, a third thin film transistor, a fourth thin film transistor, and a storage capacitance, wherein

source and gate electrodes of the first thin film transistor are interconnected to the signal output end of the upstream GoA driving unit, and drain electrode of the first thin film transistor is interconnected to a gate electrode of the second thin film transistor, a first end of a storage capacitance, and further connected to a drain electrode of the third thin firm transistor, respectively;

a source electrode of the second thin film transistor is interconnected with an output end of a clock, a gate electrode of the second thin film transistor is interconnected to the first end of the storage capacitance, a drain electrode and an signal output end of the second thin film transistor are interconnected together, and further interconnected to a source gate of the fourth thin film transistor, and a second end of the storage capacitance;

a source electrode of the third thin film transistor is interconnected to the first end of the storage capacitance, and a gate electrode of the third thin film transistor is interconnected to a signal output end of a downstream GoA driving unit, and a source electrode is interconnected to a low potential line or ground; and

a source electrode and a signal output end of the fourth thin film transistor are interconnected to the second end of the storage capacitance, a gate electrode of the fourth thin film transistor is interconnected to the signal output end of a downstream GoA driving unit, and a drain electrode of the fourth thin film transistor is interconnected to a low potential line or ground.

Wherein a clock signal output end connected to each of the GoA driving units connected by odd row of the gate lines is referred to a first clock signal output end, and wherein a clock signal output end connected to each of the GoA driving units connected by even row of the gate lines is referred to a first clock signal output end; and wherein the first and second clock signals have the same cyclic period, but with half cycle difference in polarity.

Wherein first driving signal input ends of the GoA driving units located at the upfront is each interconnected with a scanning triggering signal line so as to trigger operation of the GoA driving unit located at the upfront.

Correspondingly, the present invention further provides a liquid crystal display in accordance with another aspect, and which includes:

an array substrate;

a colorful filter substrate arranged opposite to the array substrate; and

a liquid crystal layer arranged between the array substrate and the colorful filter substrate;

wherein the array substrate includes a plurality of pixels defined by gate lines and data lines, and each of the pixels is configured with thin film transistor and pixel electrode; further including a plurality of GoA driving units used to drive a plurality of gate lines, wherein each GoA driving unit is interconnected to one gate line at an output end thereof;

wherein the GoA driving units connected with odd row of gate lines are disposed on one side of the array substrate, and wherein the GoA driving units connected with even row of gate lines are disposed on the other side of the array substrate; and

wherein each of the GoA driving units being associated with a first driving signal input end, a second driving signal input end and a signal output end, wherein the first driving signal input end is interconnected with the signal output end of an upstream GoA driving unit, and the second driving signal input end is interconnected with the signal output end of a downstream GoA driving unit, wherein the gate lines interconnected with the gate lines of the GoA driving units are interconnected to the signal output ends.

Wherein each of the GoA driving units includes a first thin film transistor, a second thin film transistor, a third thin film transistor, a fourth thin film transistor, and a storage capacitance, wherein

source and gate electrodes of the first thin film transistor are interconnected to the signal output end of the upstream GoA driving unit, and drain electrode of the first thin film transistor is interconnected to a gate electrode of the second thin film transistor, a first end of a storage capacitance, and further connected to a drain electrode of the third thin firm transistor, respectively;

a source electrode of the second thin film transistor is interconnected with an output end of a clock, a gate electrode of the second thin film transistor is interconnected to the first end of the storage capacitance, a drain electrode and an signal output end of the second thin film transistor are interconnected together, and further interconnected to a source gate of the fourth thin film transistor, and a second end of the storage capacitance;

a source electrode of the third thin film transistor is interconnected to the first end of the storage capacitance, and a gate electrode of the third thin film transistor is interconnected to a signal output end of a downstream GoA driving unit, and a source electrode is interconnected to a low potential line or ground; and

a source electrode and a signal output end of the fourth thin film transistor are interconnected to the second end of the storage capacitance, a gate electrode of the fourth thin film transistor is interconnected to the signal output end of a downstream GoA driving unit, and a drain electrode of the fourth thin film transistor is interconnected to a low potential line or ground.

Wherein a clock signal output end connected to each of the GoA driving units connected by odd row of the gate lines is referred to a first clock signal output end, and wherein a clock signal output end connected to each of the GoA driving units connected by even row of the gate lines is referred to a first clock signal output end; and wherein the first and second clock signals have the same cyclic period, but with half cycle difference in polarity.

Wherein first driving signal input ends of the GoA driving units located at the upfront is each interconnected with a scanning triggering signal line so as to trigger operation of the GoA driving unit located at the upfront.

The present invention can be concluded with the following advantages when the embodiments are implemented.

In the preferred embodiment, by the implementation of using the GoA driving units located at both side of the array substrate to drive each of the gate lines of the odd and even rows, alternatively. As a result, each of the gate lines will be triggered sequentially one after another. This arrangement can tremendously reduce the estate area occupied by the driving circuit, and furthermore, the complication of the driving circuit on each side has also been reduced. This is really beneficial to the realization of narrow-boarder of the liquid crystal display device.

### BRIEF DESCRIPTION OF PREFERRED EMBODIMENTS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings. Wherein

FIG. 1 is a configurational and illustrational view of a prior art array substrate driving circuit incorporated with single-drive circuit;

FIG. 2 is a configurational and illustrational view of a prior art array substrate driving circuit incorporated with dual-drive circuit;

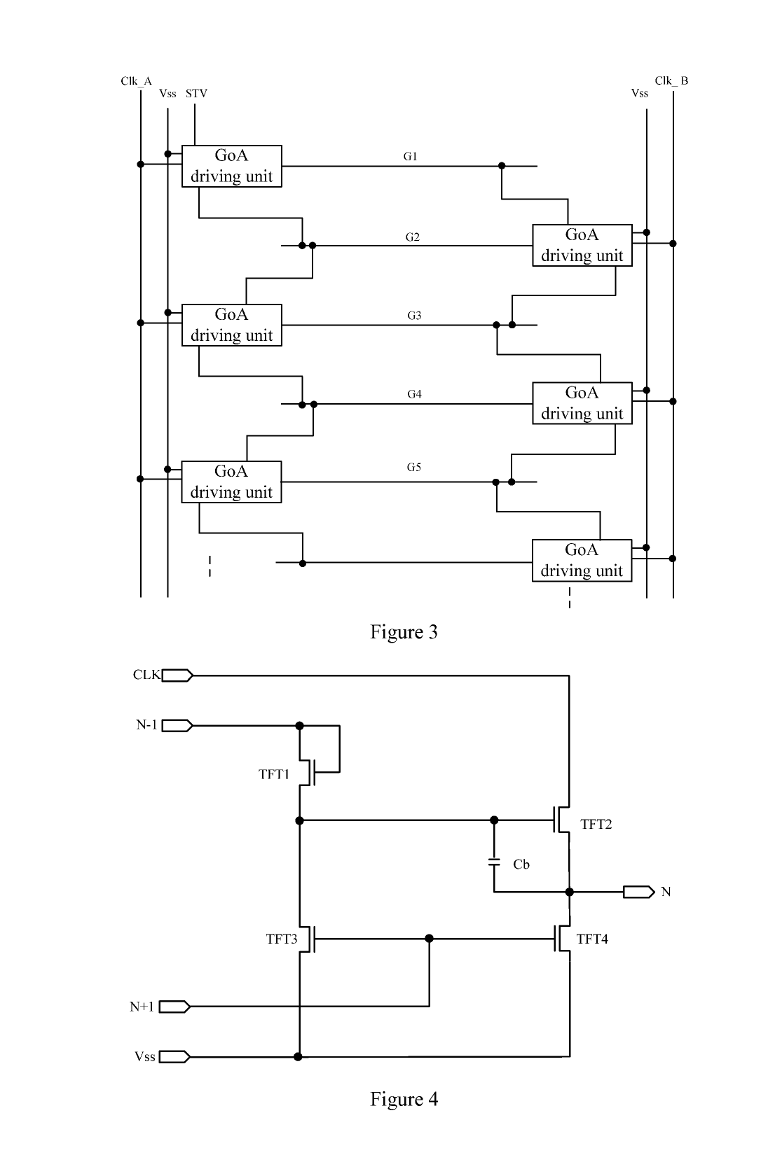

FIG. 3 is a configurational and illustrational view of an array substrate driving circuit made in accordance with the present invention;

FIG. 4 is an illustration of a working principle of a GoA driving unit in accordance with a preferred embodiment; and

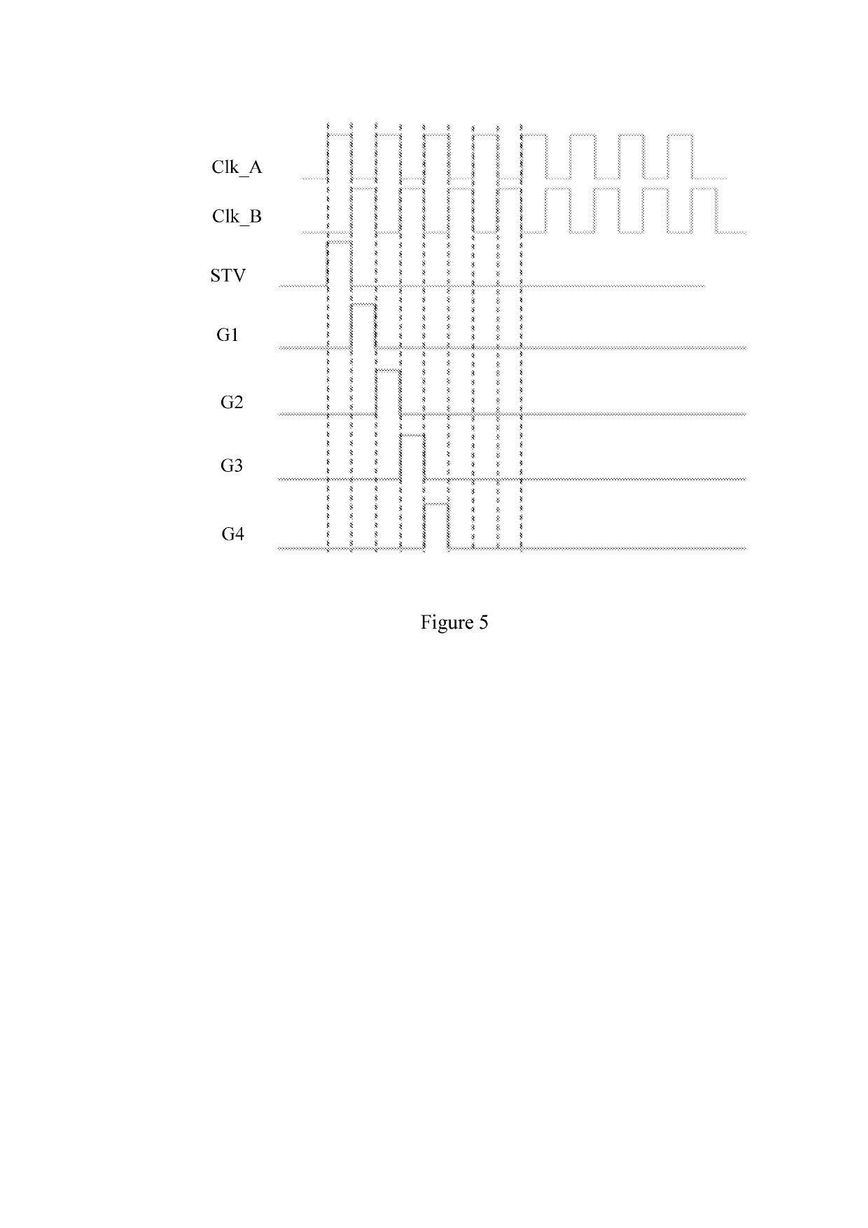

FIG. 5 is an illustration of a driving timing chart of the array substrate driving circuit made in accordance with the present invention.

### DETAILED DESCRIPTION OF PREFERRED EMBODIMENTS

Description of the embodiments will be given along with the accompanied drawings so as to illustrate the present invention can be implemented to particular embodiments. The terms of upper, lower, front, rear, left, right, internal, external, and side are merely referred and based on the orientation of the drawings. Accordingly, the use of those terms are merely for illustration, instead of limitations.

As shown in FIG. 3, a configurational and illustrational view of an array substrate driving circuit made in accordance with a preferred embodiment of the present invention, and which includes a plurality of GoA driving units used to drive a plurality of gate lines, wherein each GoA driving unit is interconnected to one gate line.

Wherein the GoA driving units connected with odd row of gate lines are disposed on one side of the array substrate, and wherein the GoA driving units connected with even row of gate lines are disposed on the other side of the array substrate; and

Wherein each of the GoA driving units being associated with a first driving signal input end, a second driving signal input end and a signal output end, wherein the first driving signal input end is interconnected with the signal output end of an upstream GoA driving unit, and the second driving signal input end is interconnected with the signal output end of a downstream GoA driving unit, wherein the gate lines interconnected with the gate lines of the GoA driving units are interconnected to the signal output ends.

Wherein first driving signal input ends of the GoA driving units a located at the upfront is each interconnected with a scanning triggering signal line (STV) so as to trigger operation of the GoA driving unit located at the upfront.

In order for easily facilitating routing of conductive traces or lines, wherein a clock signal output end connected to each of the GoA driving units connected by odd row of the gate lines is referred to a first clock signal output end Clk_A, and wherein a clock signal output end connected to each of the GoA driving units connected by even row of the gate lines is referred to a first clock signal output end Clk_B. In order to have the GoA driving units arranged on both sides of the array substrate to drive the gate lines alternatively, the first and second clock signals are set to have the same cycle length, while with half lapse in cycle. That is to say when the first clock signal is at high voltage level, then the second clock signal is at low voltage level, and vise versa, when the first clock signal is at low voltage level, then the second clock signal is at high voltage level.

On the other hand, both sides are arranged with a low potential input line (Vss) which are interconnected to the GoA driving units respectively. It can be readily understood that in other embodiment, the low potential input line can be replaced with direct grounding.

As shown in FIG. 4, an illustration of working principle of GoA driving unit of an embodiment shown in FIG. 3 is shown. Please also referring to FIG. 5, a driving timing chart of GoA driving unit is shown. In this embodiment, each of the GoA driving units includes a first thin film transistor TFT 1, a second thin film transistor TFT 2, a third thin film transistor TFT 3, a fourth thin film transistor TFT 4, and a storage capacitance Cb.

A source electrode and a gate electrode of the first thin film transistor TFT 1 are used to serve as the first driving signal input end, and are interconnected with a signal output end N−1 of a upstream GoA driving unit, a drain electrode of the first thin film transistor TFT 1 is interconnected to a gate electrode of the second thin film transistor TFT 2, the first end of the storage capacitance Cb, and a drain electrode of the third thin film transistor TFT 3, respectively.

A source electrode of the second thin film transistor TFT 2 is interconnected to an output end of a clock signal, a gate electrode of the second thin film transistor TFT 2 is interconnected to the first end of the storage capacitance Cb, and a drain electrode of and a signal output end of the second thin film transistor TFT 2 are interconnected together, and further interconnected to a source electrode of the fourth thin film transistor TFT 4, and the second end of the storage capacitance Cb.

A source electrode of the third thin film transistor TFT 3 is interconnected to the first end of the storage capacitance Cb, and a drain electrode of the third thin film transistor TFT 3 is used as a second driving signal input end, and further interconnected to a signal output end N+1 of a downstream GoA, and a source electrode of the third thin film transistor TFT 3 is interconnected to a low potential input line (Vss) or ground.

A source electrode and a signal output end N of the fourth thin film transistor TFT 4 are interconnected to the second end of the storage capacitance Cb, a gate electrode of the fourth thin film transistor TFT 4 is interconnected to a signal output end N+1 of a downstream GoA driving unit, and a drain electrode of the fourth thin film transistor is interconnected to a low potential input line (Vss) or ground.

The working principle of the GoA driving unit shown in FIG. 4 will be detailed described along with the timing chart shown in FIG. 5. The working principle is described below.

In the N−1 period, i.e. working period of upstream GoA driving unit, the input signal of the signal output end N−1 is at high voltage level, while Clk signal is at low voltage level, and the signal output end N+1 of the downstream GoA is at low voltage level. In this situation, the first thin film transistor TFT 1 and the second thin film transistor TFT 2 are in “normally closed” status, while the third thin film transistor TFT 3, the fourth thin film transistor TFT 4 are “normally opened”. The output signal of the first thin film TFT 1 is at high voltage level, and the storage capacitance Cd starts charging with the driving of the output signal (high voltage level) of the first thin film transistor TFT 1.

While in the N period, i.e. the working period of the GoA driving unit, the signal output end N−1 of the upstream GoA driving unit is at low voltage level, the Clk signal is at high voltage level, and the signal output end N+1 of the downstream GoA driving unit is at low voltage level. In this condition, the first thin film transistor TFT 1, the third thin film transistor TFT 3, and the fourth thin film transistor TFT 4 are “normally opened”, while the second thin film transistor TFT 2 is “normally closed”, and provides a high voltage level signal at the signal out put end N.

While in the N+1 period, i.e. the working period of the downstream GoA driving unit, the signal output end N−1 of the upstream GoA driving unit is at low voltage level, the Clk signal is at low voltage level, and the signal output end N+1 of the downstream GoA driving unit is at high voltage level. In this condition, the third thin film transistor TFT 3 and the fourth thin film transistor TFT 4 are “normally closed”, while the first thin film transistor TFT 1, the second thin film transistor TFT 2 and the fifth thin film transistor TFT 5 are “normally opened”. When the third thin film transistor TFT 3 is “normally closed”, the storage capacity Cd is connected to low voltage level or ground and starts to discharge. When the fourth thin film transistor TFT 4 is “normally closed”, the signal output end N of the downstream GoA driving unit is connected to low voltage level or ground, and starts to discharge.

By this arrangement, it facilitates the implementation of using the GoA driving units located at both side of the array substrate to drive each of the gate lines of the odd and even rows, alternatively. As a result, each of the gate lines will be triggered sequentially one after another. Substantially, a first GoA driving unit on the left side will drive a first gate line (G1), and then a first GoA driving unit on the right side will drive a second gate line (G2), then a second GoA driving unit on the left side will drive a third gate line (G3), and a second GoA driving unit on the right side will drive a fourth gate line (G4). By using the GoA driving units located at both side of the array substrate to drive each of the gate lines of the odd and even rows, alternatively. As a result, each of the gate lines will be triggered sequentially one after another.

It should be understood that as shown in FIG. 4, totally four TFT transistors and one storage capacitance are disclosed and explained with the working principle of its driving circuit. On other preferred embodiment, the number of the TFT transistor can be readily replaced with other suitable number, for example, a driving circuit configured with five TFT transistors.

In the preferred embodiment, by the implementation of using the GoA driving units located at both side of the array substrate to drive each of the gate lines of the odd and even rows, alternatively. As a result, each of the gate lines will be triggered sequentially one after another. This arrangement can tremendously reduce the estate area occupied by the driving circuit, and furthermore, the complication of the driving circuit on each side has also been reduced. This is really beneficial to the realization of narrow-boarder of the liquid crystal display device.

Correspondingly, the present invention further provides an array substrate for liquid crystal display, includes a plurality of pixels defined by gate lines and data lines, and each of the pixels is configured with thin film transistor and pixel electrode. Wherein the array substrate includes a driving circuit disclosed in FIGS. 3 to 4, and more detailedly, please refer to description in view of FIGS. 3-5. As a result, no detailed description is given herebelow.

Correspondingly, according to another aspect of the present invention, a liquid crystal display is provided and it includes an array substrate; a colorful filter substrate arranged opposite to the array substrate; and a liquid crystal layer arranged between the array substrate and the colorful filter substrate. Wherein the array substrate includes a driving circuit disclosed in FIGS. 3 to 4, and more detailedly, please refer to description in view of FIGS. 3-5. As a result, no detailed description is given herebelow.

In conclusion, with the present invention, the present invention can be concluded with the following advantages.

By the implementation of using the GoA driving units located at both side of the array substrate to drive each of the gate lines of the odd and even rows, alternatively. As a result, each of the gate lines will be triggered sequentially one after another. This arrangement can tremendously reduce the estate area occupied by the driving circuit, and furthermore, the complication of the driving circuit on each side has also been reduced. This is really beneficial to the realization of narrow-boarder of the liquid crystal display device.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. An array substrate driving circuit, including a plurality of GoA driving units used to drive a plurality of gate lines, wherein each GoA driving unit is interconnected to one gate line;
wherein the GoA driving units connected with odd row of gate lines are disposed on one side of the array substrate, and wherein the GoA driving units connected with even row of gate lines are disposed on the other side of the array substrate; and
wherein each of the GoA driving units being associated with a first driving signal input end, a second driving signal input end and a signal output end, wherein the first driving signal input end is interconnected with the signal output end of an upstream GoA driving unit, and the second driving signal input end is interconnected with the signal output end of a downstream GoA driving unit, wherein the gate lines interconnected with the gate lines of the GoA driving units are interconnected to the signal output ends.

2. The array substrate driving circuit as recited in claim 1, wherein each of the GoA driving units includes a first thin film transistor, a second thin film transistor, a third thin film transistor, a fourth thin film transistor, and a storage capacitance, wherein
source and gate electrodes of the first thin film transistor are interconnected to the signal output end of the upstream GoA driving unit, and drain electrode of the first thin film transistor is interconnected to a gate electrode of the second thin film transistor, a first end of a storage capacitance, and further connected to a drain electrode of the third thin firm transistor, respectively;
a source electrode of the second thin film transistor is interconnected with an output end of a clock, a gate electrode of the second thin film transistor is interconnected to the first end of the storage capacitance, a drain electrode and an signal output end of the second thin film transistor are interconnected together, and further interconnected to a source gate of the fourth thin film transistor, and a second end of the storage capacitance;
a source electrode of the third thin film transistor is interconnected to the first end of the storage capacitance, and a gate electrode of the third thin film transistor is interconnected to a signal output end of a downstream GoA driving unit, and a source electrode is interconnected to a low potential line or ground; and
a source electrode and a signal output end of the fourth thin film transistor are interconnected to the second end of the storage capacitance, a gate electrode of the fourth thin film transistor is interconnected to the signal output end of a downstream GoA driving unit, and a drain electrode of the fourth thin film transistor is interconnected to a low potential line or ground.

3. The array substrate driving circuit as recited in claim 2, wherein a clock signal output end connected to each of the GoA driving units connected by odd row of the gate lines is referred to a first clock signal output end, and wherein a clock signal output end connected to each of the GoA driving units connected by even row of the gate lines is referred to a first clock signal output end; and wherein the first and second clock signals have the same cyclic period, but with half cycle difference in polarity.

4. The array substrate driving circuit as recited in claim 3, wherein first driving signal input ends of the GoA driving units located at the upfront is each interconnected with a scanning triggering signal line so as to trigger operation of the GoA driving unit located at the upfront.

5. An array substrate for liquid crystal display, includes a plurality of pixels defined by gate lines and data lines, and each of the pixels is configured with thin film transistor and pixel electrode; further including a plurality of GoA driving units used to drive the plurality of gate lines, wherein each GoA driving unit is interconnected to one gate line at an output end thereof;
wherein the GoA driving units connected with odd row of gate lines are disposed on one side of the array substrate, and wherein the GoA driving units connected with even row of gate lines are disposed on the other side of the array substrate; and
wherein each of the GoA driving units being associated with a first driving signal input end, a second driving signal input end and a signal output end, wherein the first driving signal input end is interconnected with the signal output end of an upstream GoA driving unit, and the second driving signal input end is interconnected with the signal output end of a downstream GoA driving unit, wherein the gate lines interconnected with the gate lines of the GoA driving units are interconnected to the signal output ends.

6. The array substrate for liquid crystal display as recited in claim 5, wherein each of the GoA driving units includes a first thin film transistor, a second thin film transistor, a third thin film transistor, a fourth thin film transistor, and a storage capacitance, wherein
source and gate electrodes of the first thin film transistor are interconnected to the signal output end of the upstream GoA driving unit, and drain electrode of the first thin film transistor is interconnected to a gate electrode of the second thin film transistor, a first end of a storage capacitance, and further connected to a drain electrode of the third thin firm transistor, respectively;
a source electrode of the second thin film transistor is interconnected with an output end of a clock, a gate electrode of the second thin film transistor is interconnected to the first end of the storage capacitance, a drain electrode and an signal output end of the second thin film transistor are interconnected together, and further interconnected to a source gate of the fourth thin film transistor, and a second end of the storage capacitance;
a source electrode of the third thin film transistor is interconnected to the first end of the storage capacitance, and a gate electrode of the third thin film transistor is interconnected to a signal output end of a downstream GoA driving unit, and a source electrode is interconnected to a low potential line or ground; and
a source electrode and a signal output end of the fourth thin film transistor are interconnected to the second end of the storage capacitance, a gate electrode of the fourth thin film transistor is interconnected to the signal output end of a downstream GoA driving unit, and a drain electrode of the fourth thin film transistor is interconnected to a low potential line or ground.

7. The array substrate for liquid crystal display as recited in claim 6, wherein a clock signal output end connected to each of the GoA driving units connected by odd row of the gate lines is referred to a first clock signal output end, and wherein a clock signal output end connected to each of the GoA driving units connected by even row of the gate lines is referred to a first clock signal output end; and wherein the first and second clock signals have the same cyclic period, but with half cycle difference in polarity.

8. The array substrate for liquid crystal display as recited in claim 7, wherein first driving signal input ends of the GoA driving units located at the upfront is each interconnected with a scanning triggering signal line so as to trigger operation of the GoA driving unit located at the upfront.

9. A liquid crystal display, including:
an array substrate;
a colorful filter substrate arranged opposite to the array substrate; and
a liquid crystal layer arranged between the array substrate and the colorful filter substrate;
wherein the array substrate includes a plurality of pixels defined by gate lines and data lines, and each of the pixels is configured with thin film transistor and pixel electrode; further including a plurality of GoA driving units used to drive a plurality of gate lines, wherein each GoA driving unit is interconnected to one gate line at an output end thereof;
wherein the GoA driving units connected with odd row of gate lines are disposed on one side of the array substrate, and wherein the GoA driving units connected with even row of gate lines are disposed on the other side of the array substrate; and
wherein each of the GoA driving units being associated with a first driving signal input end, a second driving signal input end and a signal output end, wherein the first driving signal input end is interconnected with the signal output end of an upstream GoA driving unit, and the second driving signal input end is interconnected with the signal output end of a downstream GoA driving unit, wherein the gate lines interconnected with the gate lines of the GoA driving units are interconnected to the signal output ends.

10. The liquid crystal display as recited in claim 9, wherein each of the GoA driving units includes a first thin film transistor, a second thin film transistor, a third thin film transistor, a fourth thin film transistor, and a storage capacitance, wherein
source and gate electrodes of the first thin film transistor are interconnected to the signal output end of the upstream GoA driving unit, and drain electrode of the first thin film transistor is interconnected to a gate electrode of the second thin film transistor, a first end of a storage capacitance, and further connected to a drain electrode of the third thin firm transistor, respectively;
a source electrode of the second thin film transistor is interconnected with an output end of a clock, a gate electrode of the second thin film transistor is interconnected to the first end of the storage capacitance, a drain electrode and an signal output end of the second thin film transistor are interconnected together, and further interconnected to a source gate of the fourth thin film transistor, and a second end of the storage capacitance;
a source electrode of the third thin film transistor is interconnected to the first end of the storage capacitance, and a gate electrode of the third thin film transistor is interconnected to a signal output end of a downstream GoA driving unit, and a source electrode is interconnected to a low potential line or ground; and
a source electrode and a signal output end of the fourth thin film transistor are interconnected to the second end of the storage capacitance, a gate electrode of the fourth thin film transistor is interconnected to the signal output end of a downstream GoA driving unit, and a drain electrode of the fourth thin film transistor is interconnected to a low potential line or ground.

11. The liquid crystal display as recited in claim 10, wherein a clock signal output end connected to each of the GoA driving units connected by odd row of the gate lines is referred to a first clock signal output end, and wherein a clock signal output end connected to each of the GoA driving units connected by even row of the gate lines is referred to a first clock signal output end; and wherein the first and second clock signals have the same cyclic period, but with half cycle difference in polarity.

12. The liquid crystal display as recited in claim 11, wherein first driving signal input ends of the GoA driving units located at the upfront is each interconnected with a scanning triggering signal line so as to trigger operation of the GoA driving unit located at the upfront.
